(19) United States
(12) Patent Application Publication
(10) Pub. No.: US 2020/0042276 A1
(43) Pub. Date: Feb. 6, 2020

(54) METHOD AND SYSTEM OF PARTIALLY PROJECTING A COMPUTER SCREEN

(71) Applicant: Wistron Corporation, New Taipei City (TW)

(72) Inventors: Alice X Wang, New Taipei City (TW); Sharon Ma, New Taipei City (TW)

(21) Appl. No.: 16/147,758

(22) Filed: Sep. 30, 2018

(30) Foreign Application Priority Data
Aug. 1, 2018 (CN) 201810865191.6

(51) Int. Cl. G06F 3/14; G09G 5/14; G06F 3/0481; G06F 3/0486; G06F 3/0482

(52) U.S. Cl. CPC G06F 3/1454; G09G 5/14; G06F 3/0481; G06F 2203/04803; G06F 3/0482; G09G 2354/00; G06F 3/0486

(57) ABSTRACT

A method of partially projecting a computer screen includes electrically connecting a computer to a single projector; opening a window on a display area of the computer screen, and dividing the window into a first area and a second area, wherein the first area defines a projection area and the second area defines a non-projection area; and transmitting only image signals corresponding to the projection area to the projector.

### CROSS-REFERENCE TO RELATED APPLICATIONS

This application claims priority to China Patent Application No. 201810865191.6, filed on Aug. 1, 2018, the entire contents of which are herein expressly incorporated by reference.

### BACKGROUND OF THE INVENTION

### 1. Field of the Invention

The present invention generally relates to projection, and more particularly to a system and method of partially projecting a computer screen.

### 2. Description of Related Art

A projector is an optical device configured to receive image signals from a computer via a transmit interface, and the received image signals are accordingly transformed into image light, which is then projected unto a projection screen through optical components.

A computer system normally includes a frame buffer (or video buffer or screen buffer) made up of a memory (e.g., a dynamic random-access memory), used to temporarily store image signals (or data) corresponding to the computer screen. When the computer is connected to the projector, the image signals of the frame buffer are transmitted to the projector and the image associated therewith is concurrently projected onto the projection screen.

However, the conventional computer system is constructed to transmit the whole of the image signals of the frame buffer to the projector. Even in a multi-projector system, the whole of the image signals of the frame buffer is transmitted to the projectors. As the entire computer screen is transmitted and projected, a user cannot utilize a portion of the computer screen for other tasks. Alternatively speaking, the user cannot hide a portion of the computer screen from projection viewers.

A need has thus arisen to propose a novel mechanism capable of partially projecting the computer screen to provide more convenience for the user who is operating projection.

### SUMMARY OF THE INVENTION

In view of the foregoing, it is an object of the embodiment of the present invention to provide a method and system of partially projecting a computer screen, in which a portion (but not a whole) of content of the window associated with an application software is transmitted to a (single) projector.

According to one embodiment, a system of partially projecting a computer screen includes a single projector and a computer. The computer is electrically connected to the projector. A window is opened on a display area of the computer screen of the computer, and is divided into a first area and a second area, wherein the first area defines a projection area and the second area defines a non-projection area. Only image signals corresponding to the projection area are transmitted to the projector.

### BRIEF DESCRIPTION OF THE DRAWINGS

FIG. 1 shows a schematic diagram illustrating a system of partially projecting a computer screen according to one embodiment of the present invention;

FIG. 2 shows a flow diagram illustrating a method of partially projecting a computer screen according to one embodiment of the present invention;

FIG. 3 shows an exemplary display area of the computer screen;

FIG. 4A shows a dropdown menu of the function settings of the provided menu;

FIG. 4B shows a dropdown menu of the function projection list of the provided menu;

FIG. 4C shows a dropdown menu of the function display of the provided menu;

FIG. 4D shows a dropdown menu of the function history of the provided menu;

FIG. 4E shows computer icons for four switching modes according to the embodiment of the present invention; and

FIG. 5 shows an exemplary projection area and an exemplary selected area.

### DETAILED DESCRIPTION OF THE INVENTION

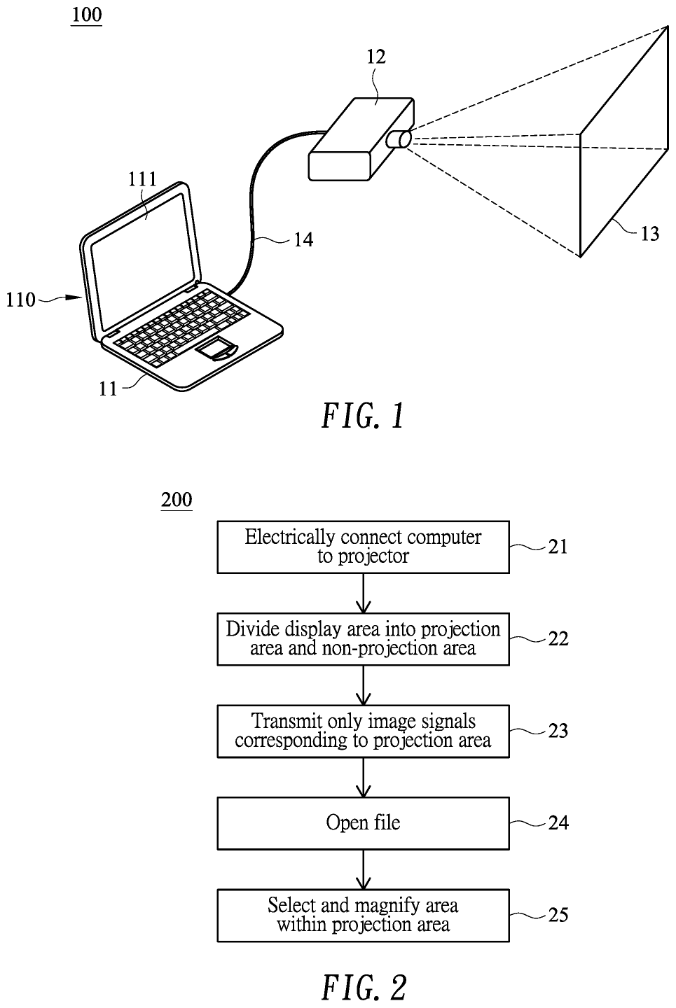

FIG. 1 shows a schematic diagram illustrating a system 100 of partially projecting a computer screen according to one embodiment of the present invention. In the embodiment, the system 100 may include a computer 11, a projector 12 and a projection screen 13. Specifically, the computer 11 may be a desktop computer, a portable computer (e.g., a notebook computer) or a handheld computer (e.g., a tablet computer or a smart phone). The computer 11 may include a computer screen 110 with a display area (or desktop) 111 used as a graphical user interface (GUI). The projector 12 may be a laser projector, a light-emitting diode (LED) projector or other types of projector. Image signals may be transmitted from the computer 11 to the projector 12 via a signal wire 14. A transmit interface between the computer 11 and the projector 12 may be Video Graphics Array (VGA), Digital Visual Interface (DVI), High-Definition Multimedia Interface (HDMI) or other transmit interfaces. The image signals may be transmitted in a wireless manner without using the signal wire 14. According to one aspect of the embodiment, the computer 11 transmits the image signals to the single projector 12. Afterward, the projector 12 transforms the received image signals into image light, which is then projected onto the projection screen 13. In another embodiment, the image light may be projected onto a wall without using the projection screen 13.

FIG. 2 shows a flow diagram illustrating a method 200 of partially projecting a computer screen 110 according to one embodiment of the present invention. The method 200 may be adapted to controllably transmitting a portion (but not a whole) of content of the computer screen 110 to the projector 12, and the transmitted portion is then transformed into image light, which is further projected onto the projection screen 13. The method 200 of the embodiment may be implemented by an application software or program (APP), which may be stored in a computer readable medium (e.g., a memory) readable by the computer 11 and be executed by the computer 11.

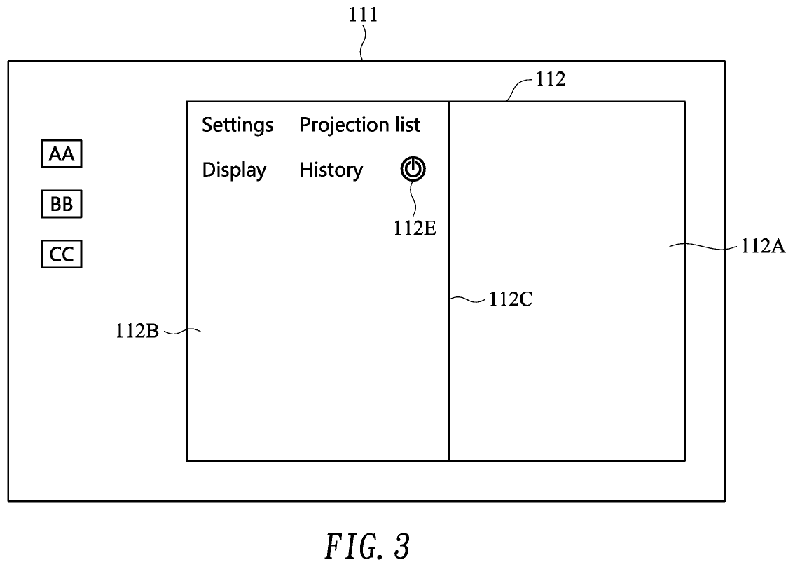

In step 21, the computer 11 is electrically connected to the projector 12 in a wire or wireless manner. Next, in step 22, the application software corresponding to the method 200 is executed, and a display area 111 of the computer screen 110 is divided into a projection area and a non-projection area. FIG. 3 shows an exemplary display area 111 of the computer screen 110.

Specifically, a window 112 corresponding to the application software of the method 200 is opened on the display area 111. A first area 112A (e.g., the right-hand side) of the window 112 is defined as the projection area, and a second area 112B (e.g., the left-hand side) of the window 112 along with the display area 111 not covered by the window 112 are defined as the non-projection area. In this example, the first area 112A and the second area 112B are separated by a separating line 112C. According to another aspect of the embodiment, only a portion (but not a whole) of content of the window 112 corresponding to the application software of the method 200 is transmitted to the (single) projector 12. In other words, a portion of image of the opened window 112 is transmitted to the (single) projector 12.

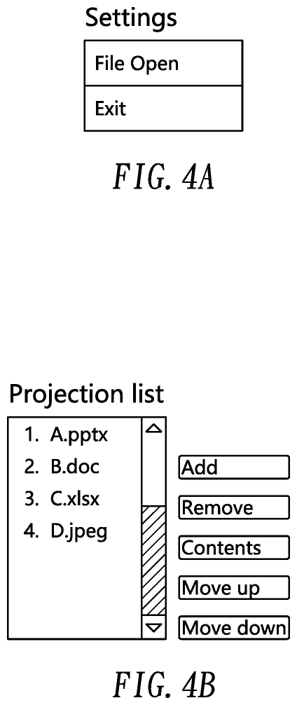

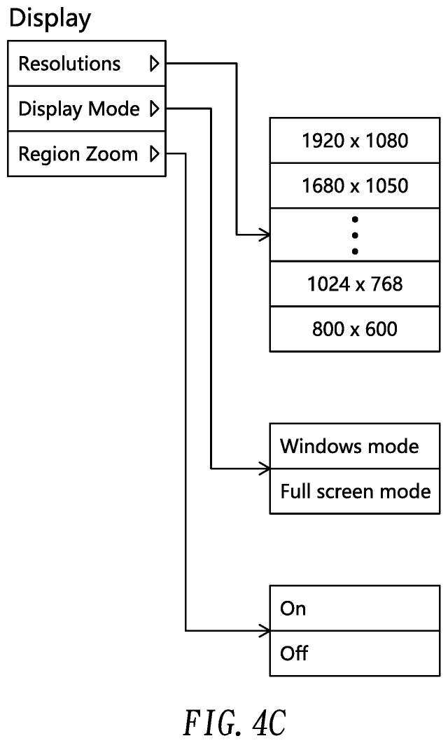

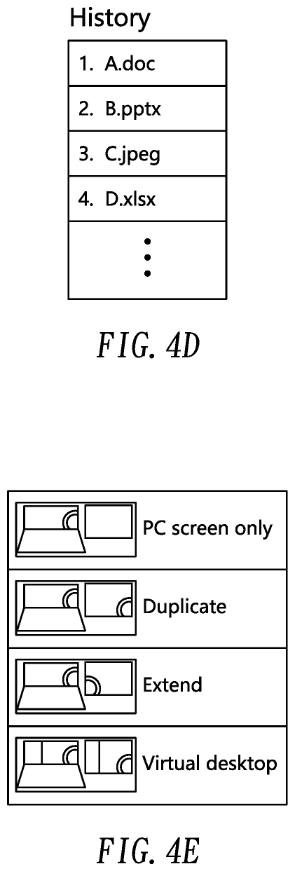

In the embodiment, the second area 112B of the window 112 of the method 200 may provide a menu with the following functions: settings, projection list, display and history. FIG. 4A shows a dropdown menu of the function settings of the provided menu. The dropdown menu may include the following sub-functions: file open and exit. Specifically, the sub-function file open may be selected by pointing and clicking to open a file to be projected; and the sub-function exit may be selected by pointing and clicking to exit the application software of the method 200. FIG. 4B shows a dropdown menu of the function projection list of the provided menu. The dropdown menu may include the following sub-functions: add, remove, contents, move up and move down, according to which a user may construct a list of files to be projected in sequence. FIG. 4C shows a dropdown menu of the function display of the provided menu. The dropdown menu may include the following sub-functions: resolutions, display mode and region zoom. Specifically, the sub-function resolutions may be selected by pointing and clicking to select a resolution of image to be projected; the sub-function display mode may be selected by pointing and clicking to set the display as window mode or full screen mode; and the sub-function region zoom may be selected by pointing and clicking to turn on or off the operation of region zoom. FIG. 4D shows a dropdown menu of the function history of the provided menu. The dropdown menu may keep a record of files previously opened, one of which may be selected again by pointing and clicking.

Referring back to the flow diagram of FIG. 2, in step 23, the application software of the method 200 transmits only image signals (or data) corresponding to the projection area (i.e., the first area 112A) of the window 112 to the projector 12 via the signal wire 14, and the transmitted image signals are then transformed into image light to be projected onto the projection screen 13. It is noted that image signals corresponding to the non-projection area (i.e., the second area 112B of the window 112 and the display area 111 not covered by the window 112) are not transmitted to the projector 12.

In the embodiment, the computer 11 may provide the following switching modes for display: (1) PC screen only; (2) duplicate; (3) extend; and (4) virtual desktop. FIG. 4E shows computer icons for four switching modes according to the embodiment of the present invention. When the switching mode virtual desktop is selected by pointing and clicking the corresponding icon, the mechanism of partially projecting the computer screen 110 of the embodiment may be activated.

In step 24, a file to be projected is opened. The embodiment provides four ways of opening the file: (1) a file (e.g., AA, BB or CC as exemplified in FIG. 3) displayed on the display area 111 not covered by the window 112 may be dragged to the first area 112A of the window 112 to open the file; (2) the function settings provided in the menu of the window 112 is selected, followed by selecting the sub-function file open in the dropdown menu (FIG. 4A) to open the file; (3) the function history provided in the menu of the window 112 is selected, followed by selecting a file previously opened as displayed in the dropdown menu (FIG. 4D) to open the file; and (4) the function projection list provided in the menu of the window 112 is selected, followed by selecting files as displayed in the projection list (FIG. 4B), which is constructed by the sub-function add, to open the files in sequence. After the file is opened, the content of the file may be displayed on the projection area (i.e., the first area 112A), image signals of which may be concurrently transmitted to the projector 12.

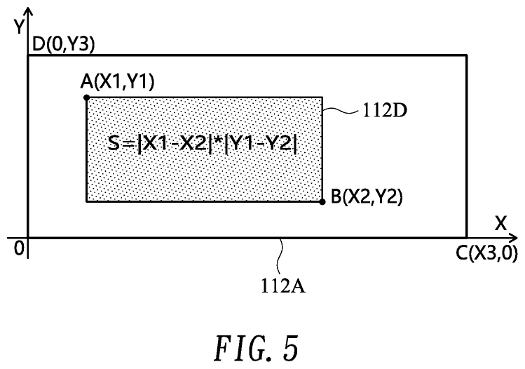

In order to view the image to be projected onto the projection screen 13 more clearly, in step 25, an area within the projection area 112A of the window 112 is selected (by a user). Subsequently, the application software of the method 200 obtains magnifying factors according to side lengths of the selected area and the projection area 112A. The selected area is then magnified (or zoomed) to substantially fill the projection area 112A according to the magnifying factors, and image signals corresponding to the projection area 112A with the magnified area are concurrently transmitted to the projector 12. FIG. 5 shows an exemplary projection area 112A and an exemplary selected area 112D. In this example, the projection area 112A has a side length X3 along X-axis direction, and the selected area 112D has a corresponding side length |X1−X2|. Accordingly, the magnifying factor along X-axis direction is X3/(|X1−X2|). Similarly, the projection area 112A has a side length Y3 along Y-axis direction, and the selected area 112D has a corresponding side length |Y1−Y2|. Accordingly, the magnifying factor along Y-axis direction is Y3/(|Y1−Y2|).

In the embodiment, as shown in FIG. 3, the menu of the window 112 of the method 200 may further provide a recovery button 112E. When the recovery button 112E is selected by pointing and clicking, the magnified area may be returned to the original selected area 112D.

Although specific embodiments have been illustrated and described, it will be appreciated by those skilled in the art that various modifications may be made without departing from the scope of the present invention, which is intended to be limited solely by the appended claims.

What is claimed is:

1. A method of partially projecting a computer screen, comprising:
electrically connecting a computer to a single projector;
opening a window on a display area of the computer screen of the computer, and dividing the window into a first area and a second area, wherein the first area defines a projection area and the second area defines a non-projection area; and
transmitting only image signals corresponding to the projection area to the projector.

2. The method of claim 1, wherein the image signals are transmitted to the projector via a signal wire.

3. The method of claim 1, further comprising a step of defining the display area not covered by the window as the non-projection area.

4. The method of claim 1, further comprising a step of displaying a menu containing a plurality of functions on the second area.

5. The method of claim 1, wherein the projector transforms the image signals to image light to be projected.

6. The method of claim 5, wherein the projector projects the image light onto a projection screen.

7. The method of claim 1, further comprising:
opening a file, content of which is displayed on the projection area, and the image signals corresponding to the projection area are concurrently transmitted to the projector.

8. The method of claim 7, further comprising:
defining a selected area within the projection area; and
obtaining magnifying factors according to side lengths of the selected area and the projection area, the selected area being magnified to substantially fill the projection area according to the magnifying factors, and the image signals corresponding to the projection area being concurrently transmitted to the projector.

9. The method of claim 7, wherein the file is opened by one of the following ways:
dragging the file displayed on the display area not covered by the window to the first area of the window;
selecting a function settings in a menu displayed on the second area, followed by selecting a sub-function file open in an associated dropdown menu;
selecting a function history in the menu displayed on the second area, followed by selecting the file previously opened as displayed in an associated dropdown menu; and
selecting a function projection list in the menu displayed on the second area, followed by selecting the file as displayed in a projection list that is constructed by a sub-function add in an associated dropdown menu.

10. A system of partially projecting a computer screen, comprising:
a single projector; and
a computer electrically connected to the projector;
wherein a window is opened on a display area of the computer screen of the computer, and is divided into a first area and a second area, the first area defining a projection area and the second area defining a non-projection area; and only image signals corresponding to the projection area are transmitted to the projector.

11. The system of claim 10, further comprising a signal wire, through which the image signals are transmitted to the projector.

12. The system of claim 10, wherein the display area not covered by the window is defined as the non-projection area.

13. The system of claim 10, wherein a menu containing a plurality of functions is displayed on the second area.

14. The system of claim 10, wherein the projector transforms the image signals to image light to be projected.

15. The system of claim 14, further comprising a projection screen, onto which the image light is projected.

16. The system of claim 10, wherein the computer opens a file, content of which is displayed on the projection area, and the image signals corresponding to the projection area are concurrently transmitted to the projector.

17. The system of claim 16, wherein a selected area is defined within the projection area; and magnifying factors are obtained according to side lengths of the selected area and the projection area, the selected area being magnified to substantially fill the projection area according to the magnifying factors, and the image signals corresponding to the projection area being concurrently transmitted to the projector.

18. The system of claim 16, wherein the file is opened by one of the following ways:
dragging the file displayed on the display area not covered by the window to the first area of the window;
selecting a function settings in a menu displayed on the second area, followed by selecting a sub-function file open in an associated dropdown menu;
selecting a function history in the menu displayed on the second area, followed by selecting the file previously opened as displayed in an associated dropdown menu; and
selecting a function projection list in the menu displayed on the second area, followed by selecting the file as displayed in a projection list that is constructed by a sub-function add in an associated dropdown menu.
